(19) United States
(12) Patent Application Publication
(10) Pub. No.: US 2017/0055498 A1
(43) Pub. Date: Mar. 2, 2017

(54) Retention Safety Devices and Uses

(71) Applicants: Jason David McNulty, Somerset, WI (US); Timothy McNulty, Somerset, WI (US)

(72) Inventors: Jason David McNulty, Somerset, WI (US); Timothy McNulty, Somerset, WI (US)

(21) Appl. No.: 14/843,519

(22) Filed: Sep. 2, 2015

(51) Int. Cl. A01K 15/02; B29C 45/00; B29C 45/16; F16B 7/04; B29C 65/56

(52) U.S. Cl. CPC A01K 15/026; F16B 7/04; B29C 65/565; B29C 45/1671; B29C 45/0053; B29L 2031/529

(57) ABSTRACT

Described herein are retention devices and their use to limit the accessible length of an elongated object, where unfettered access to the full length of the elongated object would pose a safety hazard. In some exemplary embodiments an animal safety device is disclosed that clamps onto an elongated chewable object so as to provide an animal (e.g., a domesticated animal such as a dog) a segment of chewable material while avoiding a choking hazard.

### CROSS REFERENCES TO RELATED APPLICATIONS

This application claims priority to U.S. Provisional Application Ser. No. 62/032,214 filed on Aug. 1, 2014, which incorporated herein by reference in its entirety.

### BACKGROUND

In many instances there is a need to adjust and fix the accessible length of an elongated object (e.g., a rope, a wire, or a chewable object) to prevent a potential hazard. For example, pet dogs are commonly given elongated chewable treats made of rawhide, bone or rubber, which, if swallowed whole, can result in choking or intestinal blockage. Such chewable objects could be enjoyed much more safely if they were provided embedded within an object that impedes swallowing of such chewable objects.

### BRIEF SUMMARY

Disclosed herein are retention safety devices that limit the accessible length of an elongated object, where unfettered access to the full length of the elongated object would pose a safety hazard. In some exemplary embodiments an animal safety device is disclosed that clamps onto an elongated chewable object so as to provide an animal (e.g., a domesticated animal such as a dog) a segment of chewable material while avoiding a choking hazard.

Accordingly in one aspect provided herein is a retention device comprising:

(i) a top fastening portion comprising a tapering nut comprising an internal fastening feature and an exterior retaining flange; and

(ii) a bottom fastening portion comprising a hollow bolt comprising (a) flexible pressure tabs at the top of the hollow bolt; (b) a compression sleeve disposed through the hollow bolt and surrounded by the flexible pressure tabs; (c) an external fastening feature; and (d) an exterior retaining flange; wherein (i) and (ii) are made of at least one durable material; and wherein the top fastening feature is engaged with the bottom fastening feature by inserting the hollow bolt into the tapering nut, whereby the flexible pressure tabs are compressed by the tapering nut onto the compression sleeve.

In some embodiments the fastening features are selected from the group consisting of threads, cam locks, and snap interlocks. In one embodiment the fastening features are threads.

In some embodiments the retention device further includes a cap overmolded on the top fastening portion; and a base overmolded on the bottom fastening portion; wherein (i) the cap comprises a channel having a diameter proportioned to accommodate insertion of an elongated object therethrough; (ii) the overmolded cap and base permit engagement of the top and bottom fastening features; and (iii) assembly of the overmolded cap and base by engagement of the top and bottom fastening portions yields a locked conformation shape. In some embodiments the overmolded base also includes a channel having a diameter proportioned to accommodate insertion of the elongated object therethrough.

In some embodiments, where the retention device include a cap and a base, the at least one durable material is chewing-resistant. In some embodiments the at least one durable material is selected from the group consisting of plastic, rubber, elastomer, polyurethane (e.g., thermoplastic polyurethane), composite, copolymers (e.g., ethylene vinyl alcohol, and metal. In some embodiments the durable material for the overmolded cap and base is different from the durable material for the top and bottom fastening portions.

In some embodiments the locked conformation shape is selected from the group consisting of a spheroid, a cylinder, a cone, a pyramid, a bone, a branch, and an animal.

In some embodiments the channel through the overmolded cap is circular. In other embodiments the channel through the overmolded cap is non-circular.

In some embodiments the density of the retention device following assembly of the overmolded cap and base is below about 1.0 grams per cubic centimeter.

In a further aspect provided herein is an animal safety device for retaining elongated chewable objects, comprising: (i) an overmolded cap comprising a channel having a diameter proportioned to accommodate insertion of an elongated chewable object therethrough;

(ii) a top fastening portion, overmolded by (i), and comprising a tapering nut comprising an internal fastening feature and an exterior retaining flange; (iii) a bottom fastening portion comprising a hollow bolt comprising (a) flexible pressure tabs at the top of the hollow bolt; (b) a compression sleeve disposed through the hollow bolt and surrounded by the flexible pressure tabs; (c) an external fastening feature; and (d) an exterior retaining flange; and (iv) a base overmolded on (iii); wherein: the top fastening feature is engaged with the bottom fastening feature by inserting the hollow bolt into the tapering nut, whereby the flexible pressure tabs are compressed by the tapering nut onto the compression sleeve the overmolded cap and base permit engagement of the top and bottom fastening features; assembly of the overmolded cap and base by engagement of the top and bottom fastening portions eyields a locked conformation shape; and wherein (i)-(iv) are made of at least one chew-resistant material.

In some embodiments of the animal safety device the fastening features are selected from the group consisting of threads, cam locks, and snap interlocks. In one embodiment the fastening features are threads.

In some embodiments of the animal safety device the overmolded base also includes a channel having a diameter proportioned to accommodate insertion of the elongated chewable object therethrough.

In some embodiments at least one chew-resistant material is selected from the group consisting of plastic, rubber, elastomer, polyurethane, composite, and metal. In some embodiments the chew-resistant material for the overmolded cap and base is different from the chew-resistant material for the top and bottom fastening portions.

In some embodiments the locked conformation shape is selected from the group consisting of a spheroid, a cylinder, a cone, a pyramid, a bone, and an animal. In one embodiment the locked conformation shape is a spheroid.

In some embodiments the channel through the overmolded cap is circular. In other embodiments the channel through the overmolded cap is non-circular.

In some embodiments the assembled density following assembly of the overmolded cap and base is below is below about 1.0 grams per cubic centimeter.

In a related aspect provided herein is a kit comprising the above-mentioned animal safety device and an elongated chewable object proportioned to permit insertion into the compression sleeve of the device, through the tapering nut, and through the channel in the overmolded cap, whereby when the device is in the locked conformation, a segment of the elongated chewable object is external to the molded cap, but the elongated chewable object is resistant to being pulled out of the animal safety device.

In some embodiments the elongated chewable object to be included in the kit is selected from the group consisting of: a rawhide segment, a bone segment, a rope segment, an LED lighting stick, and a plastic toy.

In yet another aspect provided herein is a method of safely providing an elongated chewable object to an animal, the method comprising:

(i) providing an elongated chewable object;

(ii) providing an animal safety device for retaining the elongated chewable object, the animal safety device comprising:
(a) an overmolded cap comprising a channel having a diameter proportioned to accommodate insertion of the elongated chewable object therethrough;
(b) a top fastening portion, overmolded by (a), comprising a tapering nut comprising an internal fastening feature and an exterior retaining flange;
(c) a bottom fastening portion comprising a hollow bolt comprising flexible pressure tabs at the top of the hollow bolt; a compression sleeve disposed through the hollow bolt and surrounded by the flexible pressure tabs; an external fastening feature; and an exterior retaining flange;
(d) a base overmolded on (c);

(iii) inserting the elongated chewable object into the compression sleeve, through the tapering nut, and through the channel in the overmolded cap;

(iv) assembling the overmolded cap and base into a locked conformation shape by engaging the bottom fastening feature by insertion of the hollow bolt into the tapering nut, whereby the flexible pressure tabs are compressed by the tapering nut onto the compression sleeve and the elongated chewable object therein thereby securing the elongated chewable object in the animal safety device; and

(v) providing the secured elongated chewable object to the animal.

### BRIEF DESCRIPTION OF THE DRAWINGS

The present invention will be better understood and features, aspects and advantages other than those set forth above will become apparent when consideration is given to the following detailed description thereof. Such detailed description makes reference to the following drawings, wherein:

FIG. 1 shows a schematic exploded view of an exemplary, non-limiting, embodiment of the retention device, e.g., a chew toy safety device have the following components: hollow bolt with external fastening feature (e.g., threads) and flexible pressure tabs (1); tapering nut with internal fastening feature (e.g., threads) (2); compression sleeve (3); tapering nut overmold cap (4); and hollow bolt overmold base (5).

FIG. 2 shows a partially exploded schematic view of the device illustrated in FIG. 1 in which the compression sleeve (3) is inside the hollow bolt (1), which is affixed to the hollow bolt overmold base (5). Not shown in this view of the device is the tapering nut, which is internal to the tapering nut overmold cap (4).

FIG. 3 shows the same schematic as FIG. 2, but with the additional illustration of an elongated object (6) inserted through the tapering nut overmold cap (4) and into the compression sleeve (3), which is surrounded by the hollow bolt (1) and its flexible pressure tabs. In this embodiment, the compression sleeve (3) hollow bolt (1) are effectively a blind hole for the elongated object.

FIG. 4 shows a schematic view of the device illustrated in FIGS. 1-3 when fully assembled. Assembly and locking of the tapering nut (2) with the hollow bolt (1) with inserted compression sleeve (3) constricts and secures the elongated object (6) and brings together the overmold cap (4) and base (5). Compression of the elongated object (6) (e.g., a rawhide treat) within the compression sleeve (3) prevents the elongated object (6) from being pulled out of the device when provided to an animal such as a dog.

FIG. 5 illustrates an embodiment of the device of FIG. 4, where the overmolded base (5) includes a channel and an external opening proportioned for insertion of the elongated object (6) through the overmold base (5), which is secured within the device as described for FIG. 4. This configuration allows an animal (e.g., a dog) access to the elongated object (6) from two sides of the device while still retaining the elongated object (6) within the device.

FIG. 6 Depicts a prototype of the embodiment of the device of shown in FIGS. 4-5 (1 and 2 respectively), where the method for manufacturing was laser sintering of Nylon 12.

FIG. 7 Depicts an example of the prototype device shown in FIG. 6, presenting a chewable “bully stick” to a Miniature American Eskimo dog.

FIG. 8 shows a schematic of the tapering nut (1) from a top view to illustrate one embodiment of the retaining flange.

FIG. 9 shows a schematic of the hollow bolt (1) from a top view to illustrate one embodiment of the retaining flange.

### DETAILED DESCRIPTION

Disclosed herein are retention devices, e.g., animal safety devices and associated methods that reduce potential hazards associated with unfettered access to the full length of certain elongated objects, such as wires, ropes, bones, or rawhide treats. In some embodiments, the device can also be used to prevent swallowing of excessively long objects by human infants or toddlers. Additional applications include using the device as a buoy when secured onto a rope on a body of water, use for securing lanterns or decorations (e.g., hanging lanterns and decorations).

In some exemplary embodiments the animal safety device secures a desired length of a chewable object (e.g., a segment of rawhide) that is safe for a pet (e.g., a dog). A key object of such devices is to an animal's ability to swallow excessively large sections of the object, which may cause health problems including intestinal blockages. An advantage of the disclosed devices is that they allow the user (e.g., a pet owner or trainer) to meter consumption of edible objects by their pet by adjusting the length of protrusion prior to clamping. This also allows for users to provide their pets with consumables which would otherwise be considered unsafe, e.g., entire rawhide bones that could be swallowed whole. The disclosed safety devices, allow an animal (e.g., a dog) to enjoy a long lasting, safe, and inexpensive treat

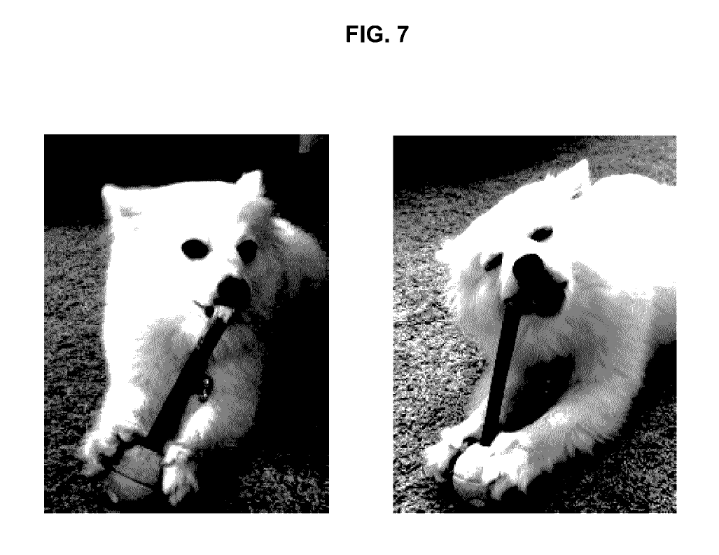

Such safety devices may be used in numerous applications including unsupervised consumption of edible treats, bones, rawhides, and rubber toys. Furthermore, such devices can be implemented into a hunting curriculum and animal water sports. In addition, the safety devices can be easily and inexpensively mass produced out of a variety of chew resistant materials (e.g., plastic, rubber, elastomer, polyurethane, composite, metal, or any combination thereof). A further advantage of the device is that it affords pets a better hold on smooth elongated objects such as rawhide segments than if such objects were presented without the aid of a device disclosed herein. See, e.g., FIG. 7. In some embodiments the retention device or animal safety device comprises a blind hole, i.e., the elongated object (e.g., a segment of rawhide) is exposed through only one side of the device, typically through an overmolded cap as described herein. In other embodiments, the devices comprise two insertion/exit holes (i.e., with channels through both the overmolded cap and base) permitting the elongated object to be inserted through the entirety of the device thereby allowing users to partially present a variety of multi-sized elongated objects, secured within the device, to an animal.

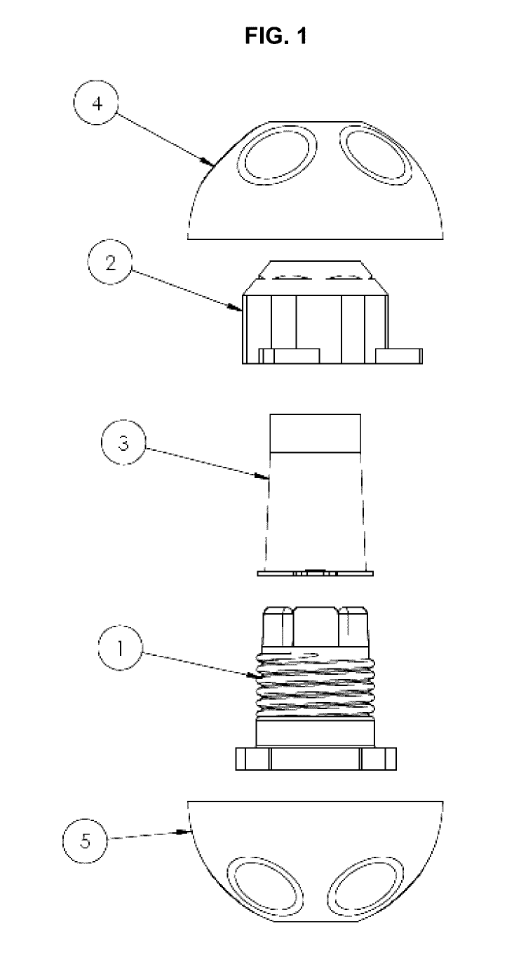

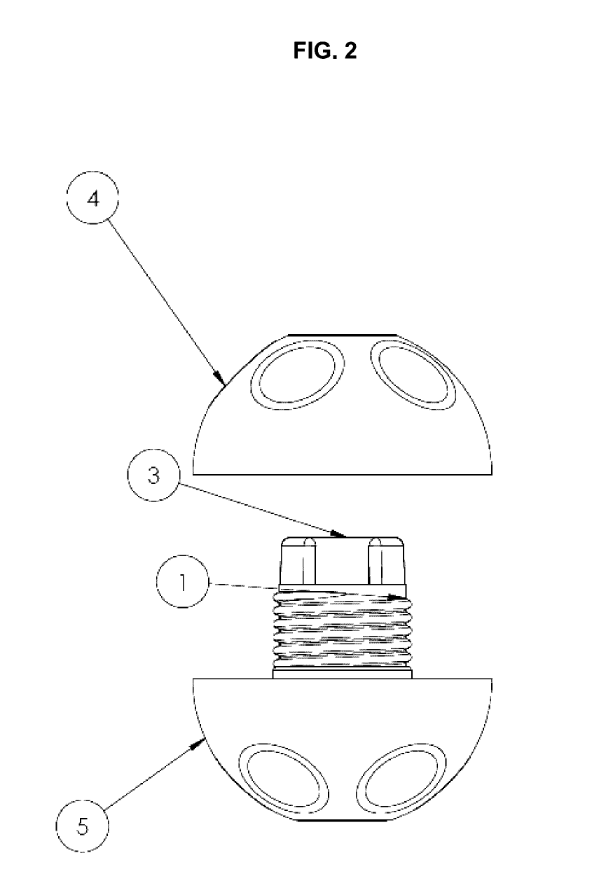

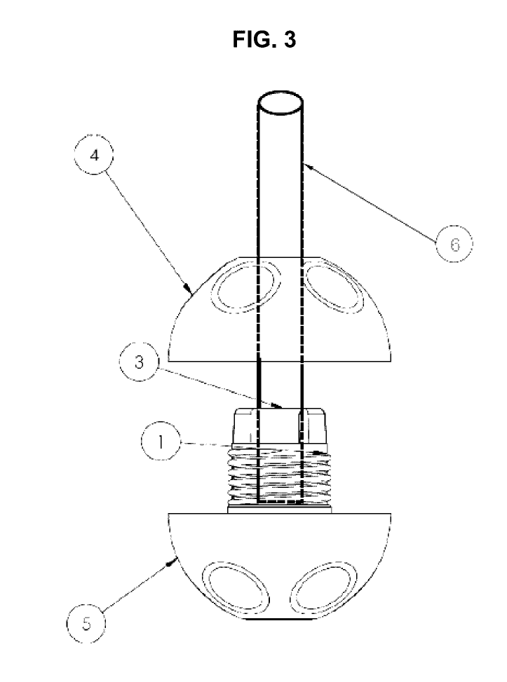

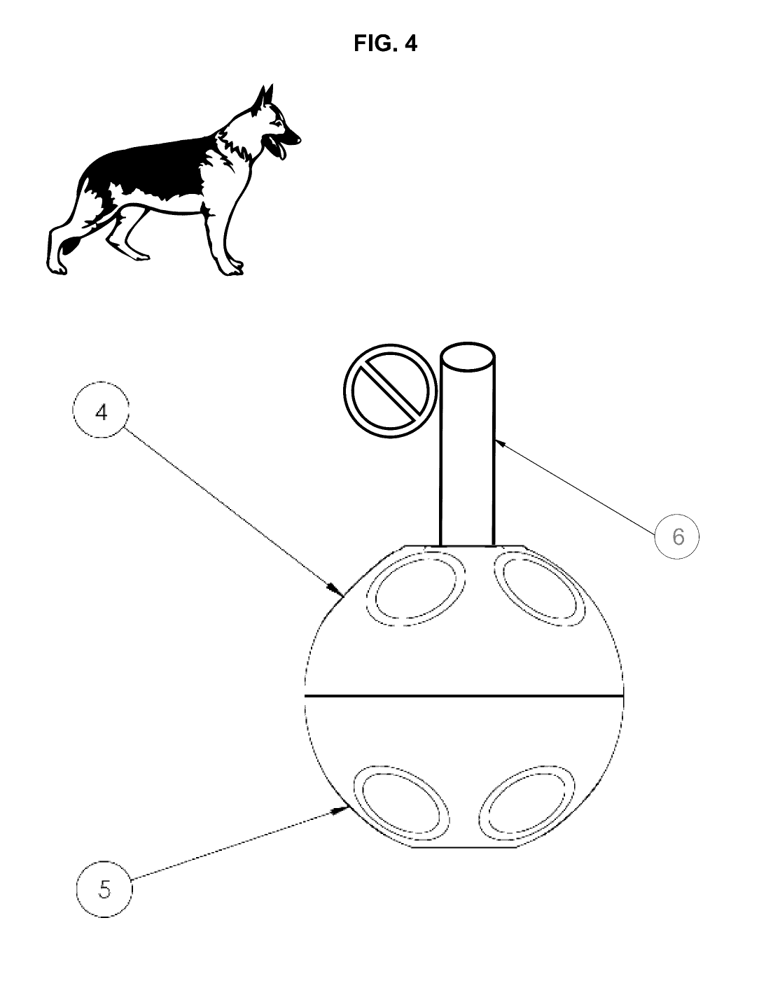

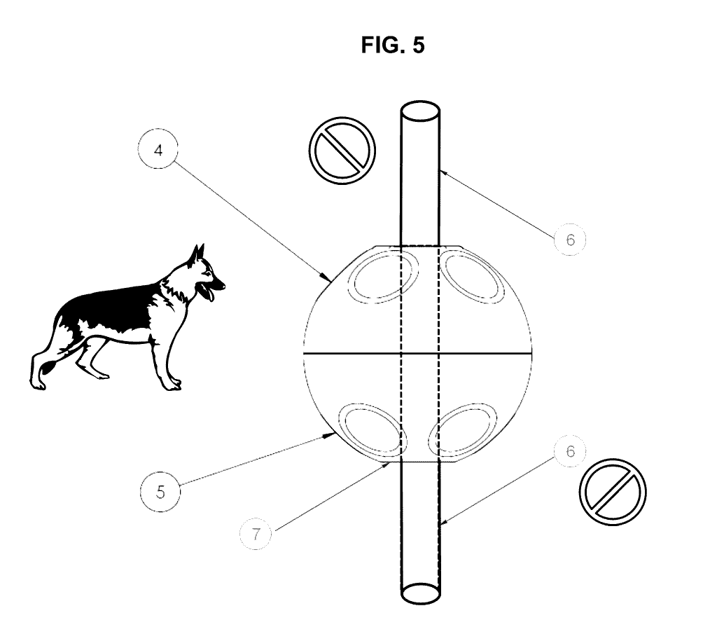

FIG. 1 depicts a number of features common to the devices disclosed herein. Such features include a compression sleeve (3), which inserts into a hollow bolt (1) comprising flexible pressure tabs and an external fastening feature such as threads, as shown in this exemplary embodiment (see also FIG. 2). The hollow bolt (1) containing the inserted compression sleeve (3) is inserted into a tapering nut (2) comprising an internal fastening feature (e.g., threads as shown in FIG. 1). As the hollow bolt (1) is engaged and fastened with the tapering nut (2), the flexible pressure tabs of the hollow bolt (1) are compressed to conform to the upper (smaller) diameter of the tapering nut (2) thereby tightening the compression sleeve (3) within the hollow bolt (1). In preferred embodiments the devices disclosed herein further comprise an overmolded cap (4), surrounding the tapering nut (2) and an overmolded base (5) attached at the bottom of the hollow bolt (1). The overmolded cap (4) includes a hole at the top proportioned to accommodate insertion of an elongated object through the tapering nut (2) inside the overmolded cap. The overmolded base (5), attached to the hollow bolt (1), optionally has a channel and hole proportioned to an elongated object to be inserted into the device so that an elongated object secured in the device is presented through both the overmolded cap (4) and the overmolded base (5). Alternatively, the overmolded base (5) comprises a blind hole such that an elongated object to be secured is inserted and presented only through the tapering nut (2) and overmolded cap (4) as shown, e.g., in FIGS. 4 and 7. Accordingly, to secure an elongated object (e.g., a chewable treat) in the device, it is inserted into the compression sleeve (3), surrounded by the hollow bolt (1) and its flexible pressure tabs, and the elongated object is inserted through the tapering nut and, in relevant embodiments, through the overmolded cap. Fastening the tapering nut (2) onto the hollow bolt (1) compresses the flexible pressure tabs around the compression sleeve (3) which tightens and retains the elongated object therein, as shown in, e.g., FIGS. 3, 4, and 7. In some embodiments, where the overmolded base includes an exit channel and hole, the inserted elongated object comes all the way through and is secured within the device, as illustrated in, e.g., FIG. 5.

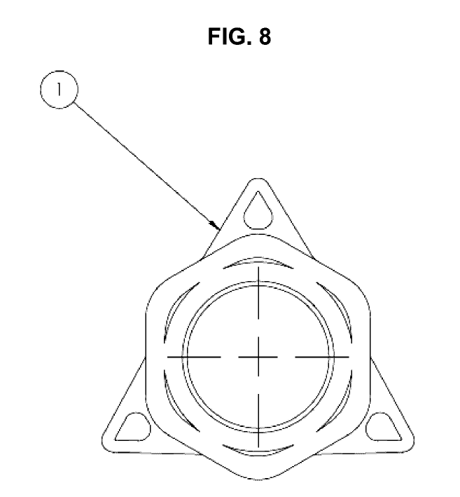

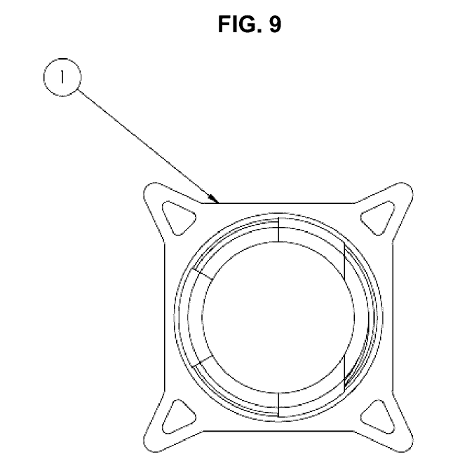

In some embodiments disclosed herein is a retention device (e.g., an animal safety device for presenting elongated chewable objects) featuring: (i) a top fastening portion comprising a tapering nut comprising an internal fastening feature and an exterior retaining flange (e.g. FIG. 8), which serves to retain the tapering nut within an overmolded cap; and (ii) a bottom fastening portion comprising a hollow bolt comprising (a) flexible pressure tabs at the top of the hollow bolt; (b) a compression sleeve disposed through the hollow bolt and surrounded by the flexible pressure tabs; (c) an external fastening feature; and (d) an exterior retaining flange (e.g. FIG. 9), which serves to secure the hollow bolt onto a base; wherein (i) and (ii) are made of at least one durable material; and wherein the top fastening feature is engaged with the bottom fastening feature by inserting the hollow bolt into the tapering nut, whereby the flexible pressure tabs are compressed by the tapering nut onto the compression sleeve.

Suitable fastening features for such devices include, but are not limited to, threads, cam locks, and snap interlocks. In a preferred embodiment the fastening features of the device are threads.

In preferred embodiments, a retention device also includes a cap overmolded onto the top fastening portion; and a base overmolded on the bottom fastening portion; wherein (i) the cap comprises a channel having a diameter proportioned to accommodate insertion of an elongated object (e.g., a chewable elongated object) therethrough; (ii) the overmolded cap and base permit engagement of the top and bottom fastening features; and (iii) assembly of the overmolded cap and base by engagement of the top and bottom fastening portions yields a locked conformation shape. In some embodiments the channel or opening in the overmolded cap or base is circular. In other cases the channel or opening has a non-circular shape (e.g., a square, rectangle, diamond, etc.). Optionally, the cap or base may include supplemental surface features, e.g., indentations, engravings, extrusions, supplemental holes (e.g., proportioned to accommodate LEDs and batteries), or textures to enhance gripping of the device. In some embodiments the overmolded base further comprises a channel and opening having a diameter proportioned to accommodate the elongated object so that it may come out through the base as well as through the cap. Although typically the cap and base join together leaving no gaps when the device is in the locked conformation, in some cases there may be a small gap between the cap and base even when the device in the locked conformation. This is permissible insofar as an elongated object inserted in the device can be tightly secured within the compression sleeve when the top and bottom fastening portions are engaged.

Suitable durable materials for making the device include, but are not limited to, plastic, rubber, elastomers, polyurethane, composites, metals, and any combinations thereof. In some embodiments, the durable material is specifically chewing-resistant, which is an advantageous feature where the device is to be used to safely present chewable elongated objects to an animal as described herein. In some embodiments all of the components of the device are made of the same durable material. In other embodiments the durable material for the overmolded cap and base is different from the durable material used for the top and bottom fastening portions. Preferably, the compression sleeve is made from a conformal and biocompatible (non-toxic) material. Suitable materials for a compressible sleeve include, but are not limited to, nitrile rubber, silicone rubber, PVC, thermoplastic polyurethane, and ethylvinyl alcohol. could be used. In embodiments in which the device includes a cap and a base, the locked conformation shape, which joins the cap and base together, can be any shape. Examples of suitable locked conformation shapes include, but are not limited to, a spheroid, a cylinder, a cone, a pyramid, a bone, and an animal shape. In some embodiments the overmolded and cap are symmetric with respect to the locked conformation of the device, e.g., two hemispheres of a ball. In other cases, the cap and base are asymmetric with respect to the locked conformation of the device, i.e., the cap and base may each have different shapes. In other embodiments the locked conformation shape comprises a gap between the overmolded cap and base, which is permissible as long as the engaged tapering nut and hollow bolt are fastened tightly enough to clamp and secure an inserted elongated object within the device.

The dimensions of the device are based, in part, on the thickness of the elongated object to be secured. In some embodiments the uncompressed diameter of the compression sleeve ranges from about 5 mm to about 25 mm, e.g., 7 mm, 9.9 mm, 12 mm, 14 mm, 16 mm, 18 mm, 20 mm, 22 mm, or another uncompressed diameter from about 5 mm to about 25 mm.

In some embodiments, the density of the retention device following assembly into the locked conformation shape is below about 1.0 g/cm³, such that the device floats in water. This is particularly useful where the device is an animal safety device used for animal recreation near bodies of water, e.g., ponds, lakes, sea, etc.

The retention and animal safety devices disclosed herein can be manufactured by a number of methods known in the art, which will be selected, in part, based on the type of durable materials to be used in the device to be manufactured. Suitable methods for generating the various components of a retention device include, but are not limited to, injection molding, compression molding, machining (turning on lathe, milling, forming, CNC etc), rapid prototyping (3D printing, fused deposition modeling, stereolithography, selective laser sintering, etc), and casting (die casting, investment casting, sand casting etc), One of skill in the art will also appreciate that, depending on the material to be used to manufacture the device, injection molding can be used to mold an entire fastening portion at the same time rather than as separate components, which may simplify the manufacturing process and reduce cost.

Also disclosed herein are kits containing an animal safety device as described herein and an elongated chewable object. Suitable elongated chewable objects for the kit include, but are not limited to, rawhide segments, bone segments, rope segments, plastic toys, light-emitting objects (e.g., LED light sticks), sound-generating objects (e.g., bells, or electronic sound emitters), aromatic objects, and rubber toys.

An application of the animal safety devices disclosed herein is a safe method of providing an elongated chewable object to an animal, which includes the steps of: (i) providing an elongated chewable object; (ii) providing an animal safety device for retaining the elongated chewable object, the animal safety device comprising:
(a) an overmolded cap comprising a channel having a diameter proportioned to accommodate insertion of the elongated chewable object therethrough;
(b) a top fastening portion, overmolded by (a), comprising a tapering nut comprising an internal fastening feature and an exterior retaining flange;
(c) a bottom fastening portion comprising a hollow bolt comprising flexible pressure tabs at the top of the hollow bolt; a compression sleeve disposed through the hollow bolt and surrounded by the flexible pressure tabs; an external fastening feature; and an exterior retaining flange;
   (iii) inserting the elongated chewable object into the compression sleeve of the just-mentioned device, through the tapering nut, and through the channel in the overmolded cap; (iv) assembling the overmolded cap and base into a locked conformation shape by engaging the bottom fastening feature by insertion of the hollow bolt into the tapering nut, whereby the flexible pressure tabs are compressed by the tapering nut onto the compression sleeve and the elongated chewable object therein thereby securing the elongated chewable object in the animal safety device; and (v) providing the secured elongated chewable object to the animal. The animals for which the method is suitable include, but are not limited to, domesticated dogs, domesticated cats; zoo mammals (e.g., bears, tigers, or lions). In some embodiments the just-described method is to present the elongated chewable object to a dog. Suitable elongated chewable objects include, but are not limited to, rawhide segments, bone segments, rope segments, plastic toys, and rubber toys.

The invention will be more fully understood upon consideration of the following non-limiting Examples.

### EXAMPLES

### Example 1

### Manufacture of the “Updog” Animal Safety Device

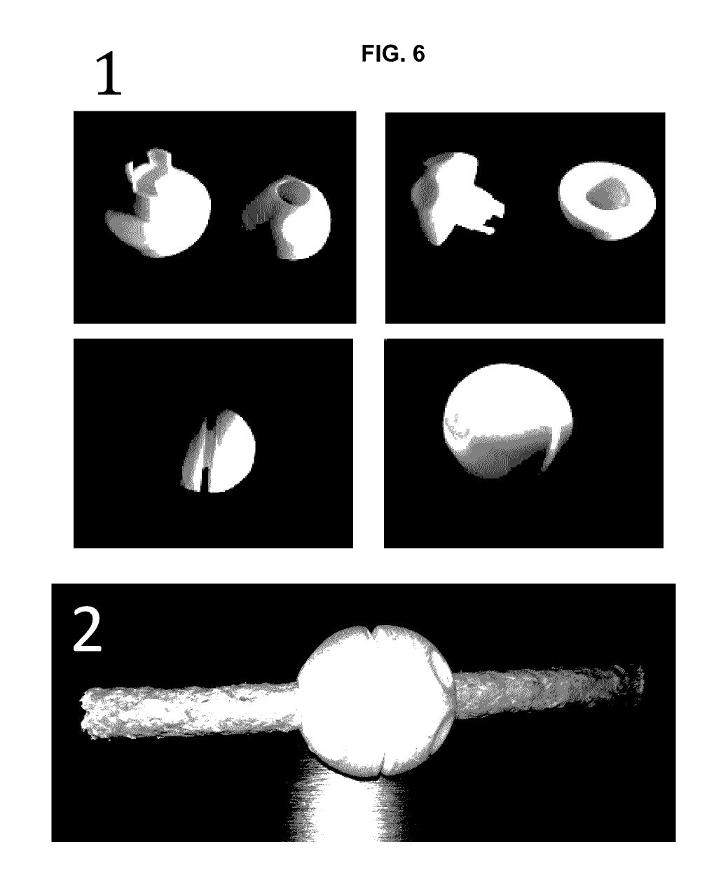

Rapid Prototyping—The prototype “Updog” animal safety devices were produced using a variety of rapid prototyping techniques including fused deposition modeling, stereolithography and selective laser sintering. Each prototype served a separate purpose; the fused deposition modeled components were used to assess proper sizing, the stereolithography components were created to show the realistic fastening features and the selective laser sintered components provided functional prototypes which could accept elongated chewable objects and fasten together properly FIGS. 6 (1 and 2).

Injection Molding—In this example the Updog animal safety device was made completely using injection molding. The hollow bolt and tapering nut were molded independently from Nylon 6 at approximately 250° C. (0% and 20% glass fiber loading respectively) prior to assembly with a compression sleeve made of nitrile rubber and subsequent insertion into a tool for overmolding. The overmolding process was performed with Thermoplastic Polyurethane (TPU) in conjunction with an endothermic chemical foaming agent such as 5767 iD 100 FC (iDadditives). Due to the chemical foaming agent, the resultant density of the Updog animal safety device was less than 1 g/cm³ so that it floats in water. The injection molded parts fit together as designed and elongated chewable objects could be restrained when inserted into the assembly.

### Example 2

### Preliminary Testing of the “Updog” Animal Safety Device

A prototype “Updog” animal safety device was manufactured utilizing selective laser sintering with the overmolded sections in a spherical formation and was presented to a number of different dogs with a variety of chewables. Specifically, twisted rawhide bones, bully sticks and ropes were inserted into the device and were presented to Miniature Golden Doodles, a Miniature American Eskimo (FIG. 7), English Labradors Retrievers, American Labrador Retrievers and American Pit Bulls ranging from 9 kgs to 35 kgs. In each case, the dogs used the device as expected—they held the device with their front paws directing the chewable upward and chewed on the secured chewable object at its free end as shown in FIG. 7. In some instances, the assembled device with chewable object inserted was used as a duck hunting training device where the trainer would throw the assembly into a lake and the dog retrieved it. In all cases, the dog was unable to remove the chewable object from the device.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass modifications and alternative arrangements within the spirit and scope of the invention as set forth in the appended claims.

What is claimed is:

1. A retention device comprising:
(i) a top fastening portion comprising a tapering nut comprising an internal fastening feature and an exterior retaining flange; and
(ii) a bottom fastening portion comprising a hollow bolt comprising (a) flexible pressure tabs at the top of the hollow bolt; (b) a compression sleeve disposed through the hollow bolt and surrounded by the flexible pressure tabs; (c) an external fastening feature; and (d) an exterior retaining flange;
wherein (i) and (ii) are made of at least one durable material; and wherein the top fastening feature is engaged with the bottom fastening feature by inserting the hollow bolt into the tapering nut, whereby the flexible pressure tabs are compressed by the tapering nut onto the compression sleeve.

2. The retention device of claim 1, wherein the fastening features are selected from the group consisting of threads, cam locks, and snap interlocks.

3. The retention device of claim 1, wherein the fastening features are threads.

4. The retention device of claim 1, further comprising a cap overmolded onto the top fastening portion; and a base overmolded on the bottom fastening portion; wherein (i) the cap comprises a channel and exterior hole having a diameter proportioned to accommodate insertion of an elongated object therethrough; (ii) the overmolded cap and base permit engagement of the top and bottom fastening features; and (iii) assembly of the overmolded cap and base by engagement of the top and bottom fastening portions yields a locked conformation shape.

5. The retention device of claim 4, wherein the overmolded base further comprises a channel and opening having a diameter proportioned to accommodate the elongated object therethrough.

6. The retention device of claim 4, wherein the at least one durable material is selected from the group consisting of a plastic, rubber, elastomer, polyurethane, composite, and metal.

7. The retention device of claim 4, wherein the locked conformation shape is selected from the group consisting of a spheroid, a cylinder, a cone, a pyramid, a bone, a branch, and an animal shape.

8. The retention device of claim 4, wherein the channel or opening through the overmolded cap is circular.

9. An animal safety device for retaining elongated chewable objects, comprising:
(i) an overmolded cap comprising a channel having a diameter proportioned to accommodate insertion of an elongated chewable object therethrough;
(ii) a top fastening portion, overmolded by (i), and comprising a tapering nut comprising an internal fastening feature and an exterior retaining flange;
(iii) a bottom fastening portion comprising a hollow bolt comprising (a) flexible pressure tabs at the top of the hollow bolt; (b) a compression sleeve disposed through the hollow bolt and surrounded by the flexible pressure tabs; (c) an external fastening feature; and (d) an exterior retaining flange; and
(iv) a base overmolded on (iii); wherein:
the top fastening feature is engaged with the bottom fastening feature by inserting the hollow bolt into the tapering nut, whereby the flexible pressure tabs are compressed by the tapering nut onto the compression sleeve the overmolded cap and base permit engagement of the top and bottom fastening features; assembly of the overmolded cap and base by engagement of the top and bottom fastening yields a locked conformation shape; and wherein (i)-(iv) are made of at least one chew-resistant material.

10. The animal safety device of claim 9, wherein the fastening features are selected from the group consisting of threads, cam locks, and snap interlocks.

11. The animal safety device of claim 9, wherein the fastening features are threads.

12. The animal safety device of claim 9, wherein the overmolded base further comprises a channel having a diameter proportioned to accommodate insertion of the elongated chewable object therethrough.

13. The animal safety device of claim 9, wherein the at least one chew-resistant material is selected from the group consisting of plastic, rubber, elastomer, polyurethane, composite, and metal.

14. The animal safety device of claim 9, wherein the locked conformation shape is selected from the group consisting of a spheroid, a cylinder, a cone, a pyramid, a bone, a branch, and an animal.

15. The animal safety device of claim 9, wherein the locked conformation shape is a spheroid.

16. The animal safety device of claim 9, wherein the channel through the overmolded cap is circular.

17. A kit comprising the animal safety device of claim 9 and an elongated chewable object proportioned to permit insertion into the compression sleeve, through the tapering nut, and through the channel in the overmolded cap, whereby when the animal safety device is in the locked conformation, a segment of the elongated chewable object is external to the molded cap, but the elongated chewable object is resistant to being pulled out of the animal safety device.

18. The kit of claim 17, wherein the elongated chewable object is selected from the group consisting of: rawhide segments, bone segments, rope segments, plastic toys, and rubber toys.

19. A safe method of providing an elongated chewable object to an animal, the method comprising:
(i) providing an elongated chewable object;
(ii) providing an animal safety device for retaining the elongated chewable object, the animal safety device comprising:
(a) an overmolded cap comprising a channel having a diameter proportioned to accommodate insertion of the elongated chewable object therethrough;
(b) a top fastening portion, embedded in (a), comprising a tapering nut comprising an internal fastening feature and an exterior retaining flange;
(c) a bottom fastening portion comprising a hollow bolt comprising flexible pressure tabs at the top of the hollow bolt; a compression sleeve disposed through the hollow bolt and surrounded by the flexible pressure tabs; an external fastening feature; and an exterior retaining flange;
(d) a base overmolded on (c);
(iii) inserting the elongated chewable object into the compression sleeve, through the tapering nut, and through the channel in the overmolded cap;
(iv) assembling the overmolded cap and base into a locked conformation shape by engaging the bottom fastening feature by insertion of the hollow bolt into the tapering nut, whereby the flexible pressure tabs are compressed by the tapering nut onto the compression sleeve and the elongated chewable object therein thereby securing the elongated chewable object in the animal safety device; and
(v) providing the secured elongated chewable object to the animal.

20. The method of claim 19, wherein the elongated chewable object is selected from the group consisting of: rawhide segments, bone segments, rope segments, plastic toys, and rubber toys.
